(19) United States
(12) Patent Application Publication
(10) Pub. No.: US 2025/0363543 A1
(43) Pub. Date: Nov. 27, 2025

(54) Real Estate Transaction System and Method

(71) Applicant: Michael Moen, Hartland, WI (US)

(72) Inventor: Michael Moen, Hartland, WI (US)

(21) Appl. No.: 19/217,469

(22) Filed: May 23, 2025

Related U.S. Application Data
(60) Provisional application No. 63/650,988, filed on May 23, 2024.

(51) Int. Cl. G06Q 30/0601; G06Q 30/02; G06Q 50/16; G06Q 50/18

(52) U.S. Cl. CPC G06Q 30/0631; G06Q 30/0281; G06Q 50/16; G06Q 50/167; G06Q 50/188

(57) ABSTRACT

A system and method for real estate transactions is provided. The system and method allows various users, including buyers, sellers, renters, landlords, and the like, to make soft connections with one another based on any number of different criteria. These soft connections allow users to initially collect some, but not all information, regarding other users and associated real estate properties. As a result, users have increased confidence in using the application or software, increasing efficiency and transparency while avoiding undesirable outcomes such as bidding wars. The system and method leverages AI technology to connect users and facilitate transactions.

This application claims priority to provisional U.S. patent application No. 63/650,988 filed May 23, 2024.

### BACKGROUND OF THE INVENTION

### 1. Field of the Invention

The present invention relates in general to the field of real estate transactions. More specifically, the present invention is directed to a system and method, including, but not limited to, an application, website, and/or software that enables connections to be made in order to facilitate buying, selling, leasing, or renting of real estate, including residential real estate. Even more specifically, the present invention allows users to establish desired criteria of real estate, at which point the system, application, website, and/or software connects users having real estate that satisfies the desired criteria.

### 2. Discussion of the Related Art

Traditional real estate transactions are well known, where an owner of a piece of land or building places the real estate on sale, after which potential buyers visit the property and make offers.

The housing market is currently facing a myriad of challenges that have significantly impacted its supply and demand dynamics. Several factors contribute to these issues, including the need for retirement homes, new construction, low interest rates, millennials entering the market, economic changes and advances, downsizing and disruption due to social challenges, migration, diseases, and urban unrest. These factors have collectively created a housing shortage, even in traditionally less populated areas like rural areas.

Firstly, the aging population and increasing life expectancy have fueled the demand for retirement homes, condos, and apartments. As more baby boomers retire, there is a growing need for housing tailored to their specific needs, such as assisted living facilities or retirement communities. This demand puts strain on the overall housing supply, particularly in areas with older populations. Many older adults are also looking to avoid assisted living facilities and are seeking homes that are smaller and more manageable. These homes are typically what a first-time homebuyer would pursue, thus increasing competition for affordable housing among millennials and older adults.

Secondly, over a decade of historically low interest rates have made mortgages more affordable, encouraging more people to enter the housing market. However, this increased demand has not been met with a proportional increase in housing supply, leading to rising prices and decreased affordability, especially for first-time homebuyers. As interest rates have increased due to inflation and economic turmoil, this also drives homebuyers and sellers to seek other less common methods of transaction to remove or bypass perceived costs associated with traditional methods of using real estate professionals. For-sale-by-owner, rent-to-own, purchasing assumable loans, and so on have removed many home sales from traditional MLS markets.

Thirdly, millennials, who make up a significant portion of the population, are now reaching the age where they desire homeownership. After years of renting or living with parents, many millennials aspire to achieve the “American dream” of owning their own home. Finally, migration from colder climates to warmer ones as well as from other countries has strained supply in certain areas. This shift in preference from renting to homeownership further strains the housing supply, as demand increases.

Moreover, economic changes and advances have reshaped the housing market. Technological advancements, changes in employment patterns, and shifts in lifestyle preferences have influenced the type of housing people seek. For instance, remote work has made suburban and rural areas more appealing, leading to increased demand in these areas and further exacerbating the housing shortage. Builders have been unable to keep up with the demand due to a number of factors, such as shortage of construction workers leading to increasing labor costs, increasing material costs due to inflation, and the like which all lead to an increased home ownership cost, as well as straining the supply by limiting purchases. The resulting lower inventory and the general perception thereof has made it more difficult to complete real estate transactions, as sellers often wait to sell until they themselves have secured new housing as a buyer.

In recent years, the COVID-19 pandemic and social unrest have also played a role in disrupting the housing market. The pandemic led to a wave of downsizing as people sought to reduce expenses or relocate to less densely populated areas. Additionally, civil unrest and riots in certain urban centers prompted some residents and businesses to leave, further impacting housing availability in affected areas. Many people, especially members of younger generations, have embraced rural living in recent years, representing a possibly untapped housing market that has been underserved by the traditional realtor-based model that prioritizes urban and suburban areas. Despite these challenges, there is an opportunity to leverage technology systems and societal shifts to address some of these issues. With people increasingly accustomed to sharing personal information and engaging on digital platforms, there is potential to use these platforms and methods for more productive purposes, such as empowering consumers in the housing market.

For instance, online platforms and other systems and methods may be utilized to facilitate easier access to information about available housing options, streamline the homebuying process, and connect buyers with relevant resources and support. By harnessing the power of technology and social media, stakeholders in the housing market may work towards making homeownership more accessible and navigating the challenges posed by the current housing shortage.

In recent years, a variety of systems and methods, including online resources, have been utilized to help facilitate real estate transactions. For instance, properties being put up for sale, rent, or lease are typically displayed on a variety of websites or applications. These postings usually include photographs of the property, as well as accompanying details associated with the property, its features, and other relevant information. This allows potential purchasers to complete preliminary research on a given property before even visiting the physical property. These tools and the empowerment they provide to users have correlated with an increase in a ‘do-it-yourself’ attitude among home buyers, but these buyers still lack certain benefits that are conferred by the use of a real estate agent, such as instruction, marketing, and personal connections. While these resources may be helpful for buyers, sellers, landlords, and tenants, further improvements are desired.

### 3. Resumé

As a result of the challenges facing the housing market and an increase in ‘off market’ sales that require having personal connections with buyers, sellers, or agents, personal connections have become more important than ever even as technology continues to change how people buy and sell homes. In addition, the limited supply of housing has increased the speed at which transactions close.

What is therefore needed is a system and/or method that allows buyers, sellers, landlords, and tenants to make connections that could result in real estate transactions. More specifically, a system and/or method, including but not limited to an application, website, or software, is desired that allows users to make initial ‘soft connections’ based on desired criteria, after which the respective parties may negotiate an agreement pertaining to the real estate. What is further needed is a system or method that helps connect buyers and sellers who are looking to pursue less traditional means of home purchasing, including for-sale-by-owner, rent-to-own, and other alternative options.

The system and/or method allows one or more buyers, sellers, renters, and landlords to make a soft connection. The soft connection allows users to learn more about the potential transaction, while still concealing some important information, such as the location of the property, the individual's name or other contact information, and the like. The soft connection is designed to test the possible buyer/seller relationship and engage with the other party in order to build interest. A combination of self-reported data and automatically acquired data will promote automated profiling enabling soft connects to occur without additional user interaction. Once each party has been properly vetted, and in some instances pay a fee, more of the previously concealed information may be shared. The system and/or method may also include intent-based matching features. The system and/or method may allow users to communicate directly if each user so decides. Additionally, the system and/or method may include data exchange mapping and associated data to provide a visual, tangible understanding of the connection.

According to another aspect of the invention, each user may insert one or more pins associated with desired locations on a map. By default, the system and/or method will automatically place pins for the user based on their level of vetting or other criteria. Pins may remain approximate locations to retain a desired level of anonymity. A user may choose to allow the system to pin their location or they may do it manually themselves. For instance, the pins may be color coded, for instance with one color being assigned to buyers, another color being assigned to sellers, yet another color being assigned to a renter, and yet another color being assigned to a landlord. Yet another color could be assigned to undecided users as well.

According to another aspect of the invention, a profile creation tool is included in the system and/or method. The profile creation tool may include one or more of a property type, a location, and a budget. Further still, the system and/or method may include a feedback and rating system. Other features may include a price selector algorithm tool and a negotiation assistance tool.

According to yet another aspect of the invention, a method of using the real estate transaction system is provided. The method may include the steps of identifying a set of desired criteria by a user and creating a soft connection between users based on the set of desired criteria. The soft connection conceals one or more identifying criteria. Additionally, the method may include revealing the concealed criteria to a third party user once a nominal fee is paid. Additionally, the method may include the step of using an algorithm to match users based on desired criteria.

This is a system and method for home-swapping using technology, including AI, as a platform and power. The home-swapping system and/or method includes matching profiles of buyers and sellers, tenants and landlords, tenants as buyers, landlords as sellers, and sellers as buyers. The system and/or method uses an auto-matching system to provide instant connections as the profiles reciprocate using the auto-matching tool. The user creates their profile guided and aided by the system and/or method for ease of use. The user will only see the speedy process and matches. The matches can be measured by strength as the connection meets the desired criteria to purchase or sell the property. For example, a buyer attracts the seller, and the seller attracts the buyer as the criteria database aligns them with one another. To have a full connection, the buyer and seller can fully connect as they subscribe to the system and/or method. They may be able to use the system and/or method for free until they want to make a connection. The system and method also may include a user-friendly authentication process for verifying other users. The system and/or method provides for transparent, honest, and ethical home transactions.

### SUMMARY AND OBJECTS OF THE INVENTION

By way of summary, the present invention is directed to a real estate transaction system. The system is a computer-implemented system and/or method that enables connections to be made in order to facilitate real estate transactions. In a preferred embodiment of the invention, the real estate transaction system is implemented by a computer processor executing instruction stored in a non-transitory computer-readable medium. A first and second user registration portal are implemented by the transaction system and are configured to receive user information preferably from remote electronic devices used by each user. The transaction system populates a first user table for capturing a first user's real estate needs and a second user table with the second user's real estate information. The system preferably includes a tool for rapidly building a user's profile, a tool to help educate the users on real estate transactions including financing and legal considerations, and a feature to verify the identity of both users. The system also may include a tool to generate matches for at least one of the users and a graphical user interface including an interactive map. The interactive map is capable of displaying one or more pins that indicate a connection between the users. The system may further include a contract generation engine that is capable of generating an executable real estate contract.

In one preferred embodiment, the first or second user can be a buyer, renter, seller, or landlord. In another preferred embodiment, the first user or second user may further enhance their profile. A second user could, for example, enhance their profile with additional data or information associated with their real estate. In yet another preferred embodiment, the system includes a tool to push one or more match connections between the seller and buyer, a first device with a display used by a first user and a second device with a display used by a second user. In another embodiment, the system includes a communications means to facilitate connection between the buyer and the seller including a means to request connection. Preferably, the system also includes a tool to get agreement between a buyer and the seller to proceed. In still another preferred embodiment, the system includes a verification system to crosscheck buyer and seller information, which allows the parties to proceed while helping to avoid the risk of scams, for example.

The system may further include a tool to facilitate a showing and further review of the real estate. In another preferred embodiment, the system includes a tool to facilitate an offer for real estate and a means to allow for negotiation of an offer, a counteroffer, and an acceptance. In yet another preferred embodiment, the system includes a tool that facilitates a formal agreement between the parties to rent, sell, or purchase real estate. Preferably, the facilitation of the agreement includes a formal contract, executing the contract, satisfying necessary inspections and/or zoning or other legal requirements and closing the transaction and transferring the real estate to the buyer.

Another preferred embodiment includes a real estate transaction system that is configured to allow users to connect. The system includes at least a first user and a second user, each in communication preferably with an input device. The system also has one or more connection devices for connecting users to the system. The system includes a table for receiving inputs from the first user input device, including desired real estate information, and a table for receiving inputs from the second user input device, including real estate location, user contact, and price information. The system preferably has an intent-based matching tool for connecting the users based on the information provided by each user. The embodiment may further include pins that are color-coded, for example, to represent various characteristics of each connection. The embodiment may further include a tool for initially concealing a specific location associated with real estate and a tool for later disclosing a specific location associated with the real estate. The embodiment preferably includes a direct communication line that is established once the user agrees to a match. The embodiment includes a system for maintaining the currency of the information and a tool for protecting the confidentiality of the information.

In one embodiment, the system includes an internet data exchange mapping and associated data tool. In another embodiment, the system includes a means to insert one or more pins to visualize a user's interest in a desired real estate location. In another embodiment, the pins could be color coded such that a first color corresponds to real estate buyers, and a second color corresponds to real estate sellers. In a further embodiment, the system includes a profile creation tool in communication with a table, wherein the profile creation tool uses information relating real estate property type, a location, and a budget. In still another embodiment, the system has a feedback and rating system and a price selector tool.

The invention may also include a method for facilitating real estate transactions. In the inventive method, at least a first and second user are registered and connected to user portals. Information is then displayed to the first and second user. The first and second users' real estate needs are captured via computer memory data tables and a profile is rapidly built for each user. A match is then generated between users based on alignment of real estate needs and real estate information as provided by the users. A graphical user interface is displayed to the users, which includes a map with one or more pins indicating a connection between users. Matches are also pushed to users in a list format where they can request to connect with one another, forming initial soft connections such that the other user's confidential identifying information is hidden from each user. Users are then prompted to decide whether or not to proceed beyond the soft connection. If they agree to proceed beyond the soft connection, the confidential information necessary to proceed is revealed. External verification of the information provided by the users is then performed. Users are then prompted to proceed with the transaction or make counteroffers. Formal closing activity is facilitated upon agreement and acceptance of an offer or counteroffer.

In a further embodiment of the invention, the method described in the above preferred embodiment could be accomplished via the use of the real estate transaction system as described in any or all of the embodiments described above, or any selection and/or combination thereof.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

A clear conception of the advantages and features constituting the present invention, and of the construction and operation of typical mechanisms provided with the present invention, will become more readily apparent by referring to the text of this application. In describing the preferred embodiments of the invention, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### BRIEF DESCRIPTION OF THE DRA WINGS

The patent or application file contains at least one drawing executed in color. Copies of this patent or patent application publication with color drawing(s) will be provided by the Office upon request and payment of the necessary fee.

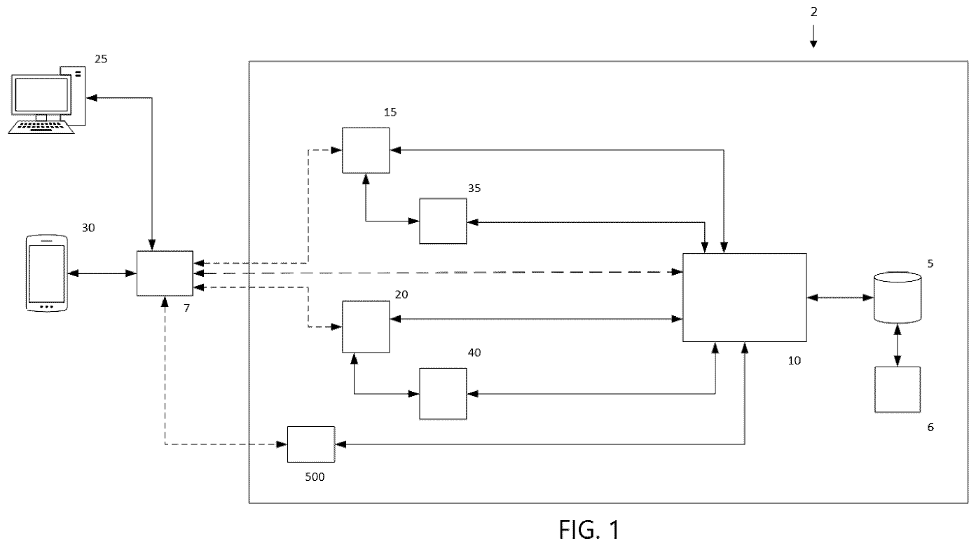

FIG. 1 is a schematic illustration of communication between devices used by a first and second user and select components of the system, according to an exemplary embodiment;

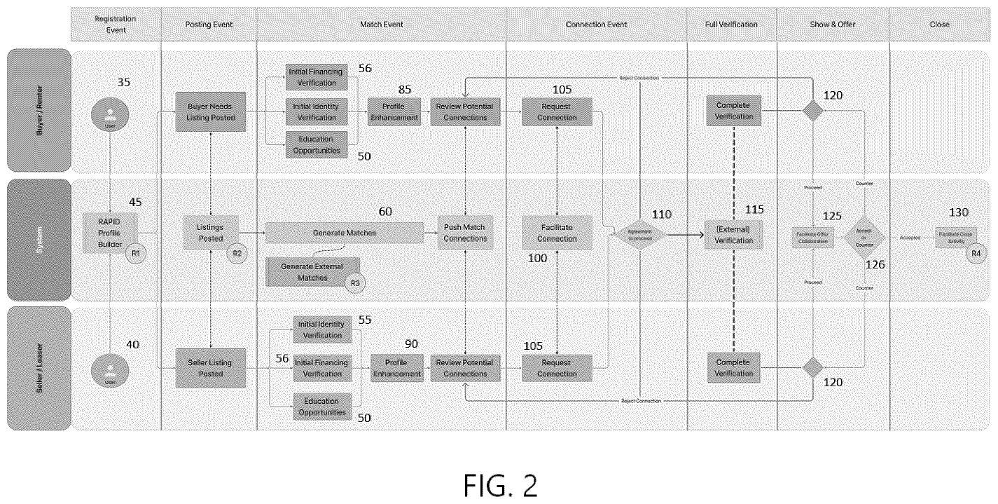

FIG. 2 is a schematic illustration of an embodiment of the invention;

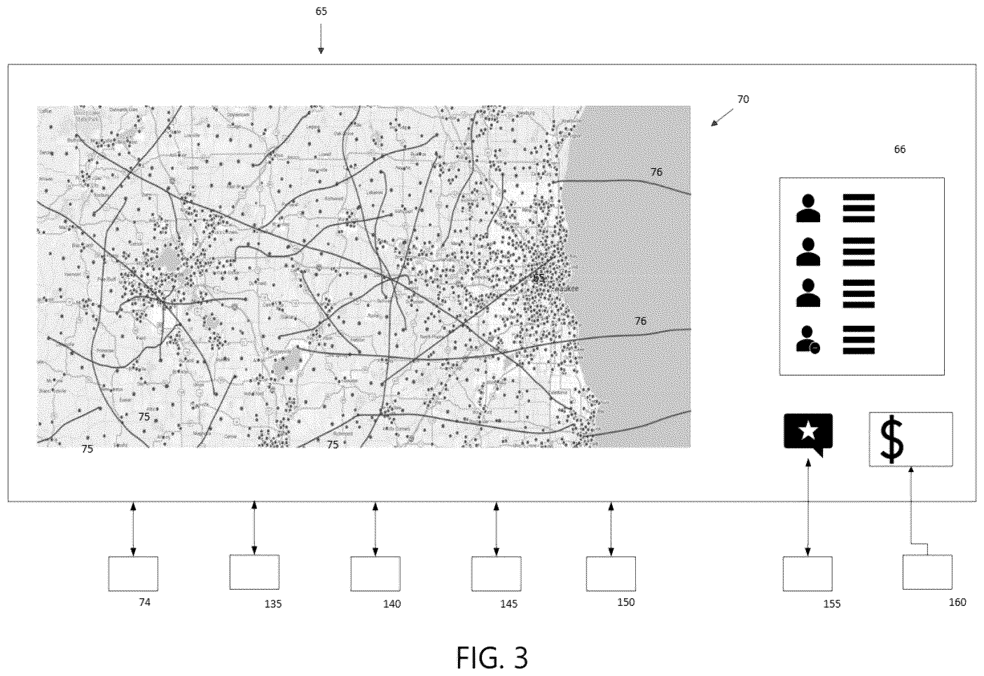

FIG. 3 is a representative schematic illustration of an embodiment of the invention including a graphical user interface and select associated tools comprising the system according to an exemplary embodiment;

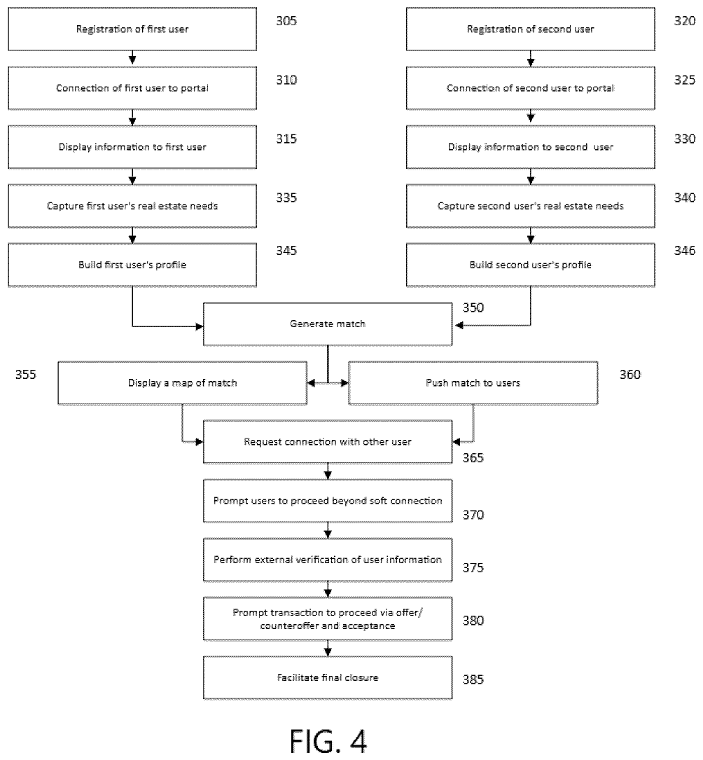

FIG. 4 illustrates a preferred embodiment of a method of performing the invention in the form of a flowchart according to an exemplary embodiment; and

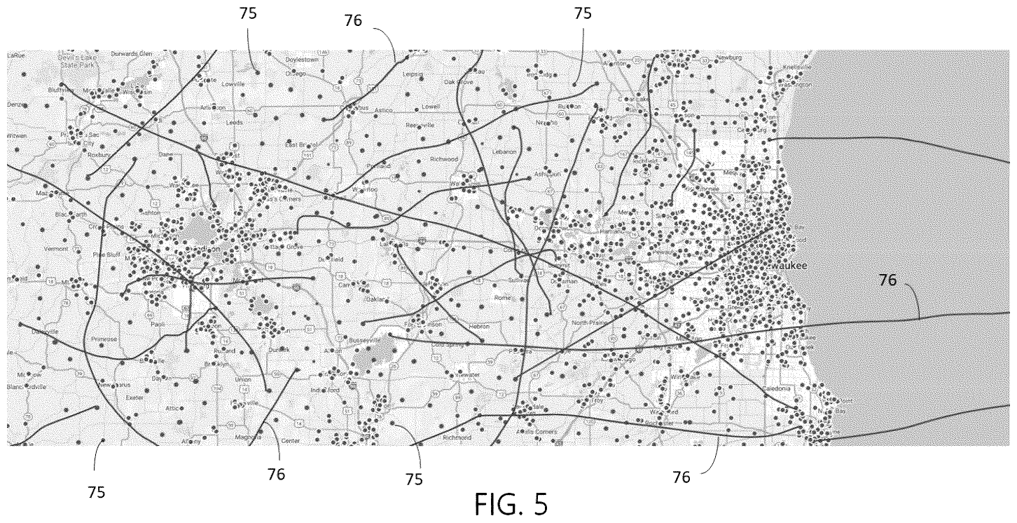

FIG. 5 illustrates the interactive map according to an embodiment of the invention.

### DESCRIPTION OF PREFERRED EMBODIMENTS

The present invention and the various features and advantageous details thereof are explained more fully with reference to the non-limiting embodiments described in detail in the following description.

### 1. System Overview

The present invention is directed to a system and/or method designed for easy use by anyone looking to sell, purchase, lease, and rent real estate, such as residential real estate for housing needs. The system and/or method will allow a user to describe their intentions to sell, buy, lease, or rent a unit/house. The user's intentions will then be discoverable to other users. At this point technology connects the users to fit their needs. Once the connection is made, they may explore it on a soft connection (the specific piece of real estate and associated parties will not be identified) and confidentiality remains until a vetting process takes place (which may include a nominal payment). The connected people will know if the other party will have a further connection as well to have the option in front of them to buy, rent or sell, basically, having the ability to make a living place exchange. The biggest problem for all home sellers/seekers is the connection. Most people would sell if they knew they had a place to go, and buyers are also scared of bid wars. Even though bid wars help a seller gain maximum sale price, it does them little good when trying to find another place to live. The present invention helps to remedy this issue by introducing transparency, a level of trust, and incentivizing mutually beneficial transactions.

The primary goal of the invention is to stimulate real estate production, instilling hope, trust, confidence, and empowerment in consumers throughout their property transactions, revolutionizing the real estate market by making the process more efficient and accessible.

The present invention is directed to a system and/or method that may be implemented via a website and mobile or other smart device application designed to streamline the process of selling, purchasing, leasing, and renting real estate, including residential real estate. The present invention addresses many of the common challenges faced by both sellers and buyers in the real estate market by leveraging advanced AI technology to facilitate connections, negotiation, and transactions.

A non-limiting list of features associated with the system and/or method will now be described. A real estate website and application employed in the system may include an intuitive user interface, making it accessible to users of all levels of technological proficiency. The website and/or application additionally is user-friendly for those who have little to no experience in terms of purchasing real estate. Whether you're a first-time homebuyer or an experienced seller, navigating the platform is fairly easy.

Additionally, the system and/or method may include intent-based matching. This feature would allow users to input their intentions regarding buying, selling, leasing, or renting a property. An AI algorithm then matches these intentions with compatible counterparts, ensuring that users are connected with individuals whose needs align with their own. The system could also be configured to display a “compatibility score” via visual representation such as color-coding or “heat-mapping” to reflect parties that are the best matches for the user in terms of goals or likelihood of closure via the predictive model.

Further still, the system and/or method allows for soft connections. “Soft connection” as used here means that when a connection is initially made, to protect user privacy and confidentiality, some, but not all, information is shared between the matched users. As such, users may explore potential matches without the pressure of revealing their full identities. This soft connection method prioritizes user privacy, allowing individuals to explore potential connections discreetly until they are ready to proceed with direct communication. Only after a vetting process, which involves a nominal fee, are users able to engage in direct communication. The system could also be configured to require pre-qualification for a home loan in order to make a full connection to expedite the closing process.

The system and/or method may also feature transparent communication. Once a connection is established, users may communicate openly and transparently. Users have access to essential information about the other party's intentions, facilitating informed decision-making. Additionally, the system and/or method may provide an option for further connection. More specifically, system and/or method provides users with the option to explore further connections beyond their initial match. This ensures that individuals have multiple opportunities to find the best housing solution, whether they are looking to buy, rent, or sell.

As a result of these features, the invention provides a number of meaningful benefits. The system and/or method provides a simplified process in comparison to the current, more complex process of residential real estate transactions, reducing the stress and uncertainty often associated with buying or selling a home.

The system and/or method also leverages certain artificial intelligence (AI) technology to improve functionality, including accelerating the matching process while connecting users with compatible counterparts in a fraction of the time it would take through traditional methods.

Further still, the system and/or method is configured to minimize bid wars. More specifically, the system and/or method addresses the fear of bid wars by providing users with viable housing options before they commit to selling their current property. This encourages more confident decision-making and reduces the likelihood of bidding wars.

Overall, the system and/or method revolutionizes the residential real estate market by facilitating seamless connections and transactions, empowering individuals to find their ideal housing solutions with confidence and ease.

Further details of the system and/or method, including but not limited to a real estate website and/or application, will be described. The system may use internet data exchange (IDX) mapping and associated data. This allows real estate professionals to display comprehensive and up-to-date property listing data. In one example, a user's pin may be used as the user's letter of intent or buyer/seller needs. More specifically, a user may easily drop pins on the map to signify their intent. The pins may be customizable in terms of color and associated information. The user's color coordinated pins are added to the map on a blurred map for confidentiality so no person may solicit the user directly. Different colors may be used to identify the user as a renter/buyer or a seller/landlord. For instance, certain users such as sellers may be red pins, certain users such as buyers may be blue pins, and certain users such as renters may be white pins. Users may filter out different colors so that they only see relevant results. In addition to the blurred map, other measures such as user authentication may be used, where only registered users may view the property information and interact with pins.

Additionally, the real estate website and application employed by the system and/or method may be configured to integrate with existing and reliable mapping services, such as Google Maps or Mapbox. Other features associated with these services may also be integrated into the real estate website and application. Layers and filters may be added to the map to show properties with specific zoning or environmental rules, for example.

To allow for further customization, the real estate website or application of the system and/or method may allow users to create profiles where they may specify various preferences, including the desired property type, location, budget, and the like. This information helps create a personalized experience, and helps to limit information to relevant property recommendations.

Another feature is messaging and communication tools. This allows users to communicate with one another regarding intentions or property listings. Of course, the messaging and communication tools are secure and compliant with privacy regulations. Push notifications may also be utilized to alert users of new listings or other relevant information. This keeps users engaged and informed of potential opportunities so as to avoid missing out on properties that may move quickly. An application employed in the system and/or method may also be equipped with advanced search and filter options. This enables a user to narrow down the property search to specific criteria, including but not limited to price range, number of bedrooms and bathrooms, desired amenities, etc. Additionally, the user may indicate preferred criteria and required criteria so as to avoid eliminating a piece of real estate based on a preference, but not something that the user absolutely requires.

Another feature of the method and/or system is a feedback and rating system. This allows users to provide feedback and ratings to properties they have viewed, or interactions they have had with other users. This helps to improve a user's experience and sense of community, while also encouraging users to act professionally and appropriately while using the system. Similarly, the method and/or system may take any feedback in terms of the user's experience, and furthermore testing may be routinely completed to ensure everything is working as it should.

The proposed system and/or method may incorporate algorithms to assist sellers in pricing their homes based on various factors, from condition to attractions or drawbacks. Simultaneously, it empowers buyers by providing insights into pricing for their desired home features. For example, the AI technology could be used to request public records that could inform either party. In addition, the AI could be used to generate a listing based on the seller's property tax bill. Enhancing sellers' comprehension of potential buyers and their purchasing power is a key facet of the method and/or system. Further still, the system and/or method may offer customers a spectrum of options and services such as negotiation assistance or consultation.

The system and/or method guides individuals towards productive outcomes in their quest to buy or sell a home. The system and/or method serves as a comprehensive solution, offering a one-party listing platform with features such as status updates, delayed listings, and consultation services, all aimed at preparing users before engaging with real estate or legal professionals. Additionally, the system and/or method offers a simplified user experience that avoids complicated forms. Instead, it offers intuitive features like video presentations for listings and effortless navigation. The system and/or method also may provide algorithmic insights. The system assists sellers in pricing their homes accurately by considering various factors such as property condition, attractions, and market dynamics. Similarly, buyers may gain insights into pricing for their desired property types based on their preferences. The algorithm may also be configured to filter or rate areas or listings by various metrics or neighborhood characteristics, such as nearby amenities, quietness, or proximity to shopping.

The website and application could also offer consultation services tailored to different levels of engagement, ensuring that users receive the support they need throughout their journey. Through negotiation services and consultation options, the invention empowers consumers to make informed decisions while helping the transparency and fairness of the transactions. The system and/or method offers productivity tools that help to streamline the buying and selling process. It acts as a preparation tool before engaging with realtors, providing consultation services and simplifying the process while creating a market that discovers all sorts of inventory available to them.

Other features may include pricing algorithms, buyer affordability insights, and negotiation consultation services. These aim to enhance personalization and efficiency in real estate transactions. The system and/or method also may help consumers gain insights into market dynamics and connect with professionals. The method and/or system may serve as a “valet” service for reality, preparing users for successful property transactions. The system and/or method preferably quickly responds to housing shortages and changing market dynamics, offering solutions for user entering the market, relocations, downsizers, economic changes, and societal shifts. Additionally, the website and application employed in the system and/or method may interface with preexisting applications and websites used for various real estate purposes. There are virtually innumerable uses for the present invention, all of which need not be detailed here. All the disclosed embodiments may be practiced without undue experimentation.

As shown in FIG. 1, real estate transaction system 2 includes a non-transitory computer-readable medium 5 storing executable instructions 6. The system also includes one or more processors 10 capable of executing the instructions. The instructions encode for various user-facing components and tools described herein in a preferred embodiment. The system includes a first user registration portal 15. The first user registration portal 15 may function as a user portal for a first user. The system also includes a second user registration portal 20. The second user registration portal 20 may function as a user portal for a second user.

A device for connecting to the first user portal 25 allows a user to connect to the first user portal. Device for connecting to first user portal 25 may be a remote electronic device. Device for connecting to first user portal 25 may be a personal computing device, such as a desktop computer, tablet, smartphone, or the like. Device for connecting to the first user portal 25 may also be an input device in communication with a first user. Device for connecting to the first user portal 25 may also contain a display for displaying information to a user. Device for connecting to the first user portal 25 may connect to the real estate transaction system 2 via an internet connection 7. A device for connecting a second user to a second user profile 30 allows a second user to connect to a second user portal. Device for connecting to a second user profile 30 may be a remote electronic device. Device for connecting a second user to a second user profile 30 may be a personal computing device, such as a desktop computer, tablet, smartphone, or the like. Device for connecting a second user to a second user profile 30 may also be an input device in communication with a second user. Device for connecting a second user to a second user profile 30 may also be a communication device for connecting users to the system. Device for connecting a second user to a second user profile 30 may also contain a display for displaying information to a user. Device for connecting a second user to a second user profile 30 may connect to the real estate transaction system 2 via an internet connection 7.

The system also includes a first user table 35 for capturing a first user's needs. First user table 35 may be a table for receiving inputs from the first user input device including desired real estate information. First user table 35 may comprise a computer memory data table. The system also includes second user table 40 for capturing a second user's real estate information. Second user table 40 may be a table for receiving inputs from the second user input device including real estate location, user contact, and price information. Second user table 40 may comprise a computer memory data table. Payment portal tool 500 is configured to allow a first or second user to make payments via an external financial institution or internet-based payment system via internet connection 7.

Turning to FIG. 2, the system also includes a tool for rapidly building a user's profile 45. Tool for rapidly building a user's profile 45 may be a profile creation tool in in communication with a table—for example, table 35 or table 40—wherein the profile creation tool includes one or more of a real estate property type, a location, and a budget. The system also includes a tool to help educate the users on real estate transactions including financing and legal considerations 50. The system also includes a tool to verify the identity of both users 55. The system may also include an initial financing verification tool 56.

The system also includes a tool to generate matches for at least one of the users 60. Tool to generate matches for at least one of the users 60 may be an intent-based matching tool for connecting the first user with the second user based on the user information. Tool to generate matches for at least one of the users 60 may also be a tool to push match connections to a buyer and seller. Pushing match connections to the users may take the form of ‘push notifications’ as understood in the art.

The system also includes a first user profile enhancement tool 85 and a second user profile enhancement tool 90. Second user enhancement tool 90 may allow a user to enhance its profile by adding additional data on the real estate, possibly using machine learning to augment or suggest data. For example, second user profile enhancement tool 90 could assist the second user in completing their listing based on tax documents or other available information corresponding to the real estate they are offering.

The system is further comprised of a communications means 100 to facilitate connections, for example, between a buyer and a seller. Communications means 100 may comprise a direct communication line between users. Communications means 100 may further comprise a direct communication line that is established once a user agrees to a match. The system also includes a means to request connection 105 with other users. The system also includes a tool to get agreement between a buyer and the seller to proceed 110. The system further includes a verification system 115 to crosscheck buyer and seller information and allow the parties to proceed. Verification system 115 may consist of external verification, such as verification of information with a third party, for example. A third party could consist of a financial institution or an employer, for example.

The system further includes a tool to facilitate a showing and further review of the real estate 120. Tool to facilitate a showing and further review of the real estate 120 could function as a scheduling tool to facilitate scheduling in-person showings, or include other methods of review of the real estate to be transacted. The system also includes a tool to facilitate an offer for real estate 125 and a negotiation assistance tool 126. Negotiation assistance tool 126 could comprise a means of allowing for a negotiation of an offer, counteroffer, and acceptance. The system also includes a tool to facilitate a formal agreement between the parties 130, wherein the tool includes a formal contract, executing the contract, satisfying necessary inspections and/or zoning or other legal requirements and closing the transaction and transferring the real estate to the buyer. Facilitation tool 130 may be a contract generation engine configured to generate an executable real estate contract.

Turning to FIG. 3, the system also includes a graphical user interface (GUI) 65. GUI 65 may be displayed on device for connecting to first user portal 25 and device for connecting a second user to a second user profile 30. GUI 65 may include a list of matches 66 that displays matches generated by match generation tool 60. GUI 65 also includes an interactive map 70. Interactive map 70 may be a map for displaying at least some of a user's information within a geographic location. Interactive map 70 may also include an internet data exchange mapping and associated data tool. As shown in more detail in FIG. 5, the map may include one or more pins that indicate connections between the users 75. Pins 75 may also allow the user to visualize their matches with other users. The system also includes a means to insert one or more pins to visualize interest in a desired real estate location 74. As shown in further detail in FIG. 5, pins 75 may be color-coded, wherein, for example, a first plurality of pins having a first color and associated with real estate buyers, and a second plurality of pins having a second color and associated with real estate sellers. Interactive map 70 may also include one or more lines 76 for visually connecting for the users the information on the map.

The system also includes a tool for initially concealing a specific location associated with real estate 135 as well as a tool for later disclosing a specific location associated with the real estate 140. The system also includes a system for maintaining the currency of the information 145 and a tool for protecting the confidentiality of the information 150 provided by users. The system may include a feedback and rating system 155 and a price selector tool 160.

FIG. 4 illustrates a preferred embodiment of a method of performing the invention in the form of a flowchart. A user first user is registered with the system in step 305 and connected to a user portal in step 310. Then, information from the system is displayed to the user in step 315. The first user's real estate needs are then captured via computer memory data tables in step 335. Concurrently with or sequentially of the first user, a second user is registered with the system in step 320 and connected to a user portal in step 325. Information from the system is displayed to the second user in step 330. The second user's real estate information is captured via computer memory data tables in step 340. A profile is rapidly built for the first user in step 345 and for the second user in step 346. The rapid profile building may employ the use of artificial intelligence in order to suggest data entry based on publicly available information, for example.

Then, in step 350, a match is generated between users wherein the matching is based on alignment of real estate needs and real estate information. In step 355, the match is displayed on a graphical user interface including a map containing one or more pins indicating a connection between users. Concurrently, in step 360, the match is pushed to the users. From either the map display or the match push, at step 365 users request to connect with one another thus forming an initial soft connection wherein confidential identifying information is hidden. After the users are able to review the connection, at step 370 users are prompted to decide whether or not to proceed beyond the soft connection whereupon the confidential information necessary to proceed is revealed. At step 375, external verification of user-provided information, such as verification of pre-qualification for a home loan with a lending institution, is performed. At step 380, users are prompted to proceed with the transaction, make offers, counteroffers, and potentially accept an offer. Finally, in step 385, final closing activity is facilitated.

In one embodiment of the invention, the first user is a buyer and the second user is a seller. In an alternative embodiment, the first user is a renter and the second user is a landlord. In a third embodiment, the first and second users may be both buyers and/or sellers who are interested in testing the housing market or who seek to both sell a house and purchase a new real estate to seamlessly transition their place of residence.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape, and assembled in virtually any configuration. Furthermore, all the disclosed features of each disclosed embodiment may be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A computer-implemented real estate transaction system implemented by a computer processor executing instruction stored in a non-transitory computer-readable medium, comprising:
a first user registration portal implemented by the transaction system configured to receive first user information from a first remote electronic device;
a second user registration portal implemented by the transaction system configured to receive second user information from a second remote electronic device;
wherein the transaction system is configured to populate a first user table for capturing a first user's real estate needs;
wherein the transaction system is configured to populate a second user table for capturing the second user's real estate information;
a tool for rapidly building a user's profile;
a tool to help educate the users on real estate transactions including financing and legal considerations;
a tool to verify the identity of both users;
a tool to generate matches for at least one of the users; and
a graphical user interface including an interactive map displaying one or more pins that indicate a connection between the users; and
a contract generation engine configured to generate an executable real estate contract.

2. The real estate transaction system of claim 1 wherein the first user is at least one of a buyer, renter, seller, and landlord.

3. The real estate transaction system of claim 2 wherein the second user is at least one of a buyer, renter, seller, and landlord.

4. The real estate transaction system of claim 1 wherein at least the first user may further enhance its profile and the second user may further enhance its profile by adding additional data on the real estate.

5. The real estate transaction system of claim 3 further comprising a tool to push match connections between the seller and buyer; one of at least a first device for use by a first user having a display and a second device for use by a second user having a display.

6. The real estate transaction system of claim 3 further comprising a communications means to facilitate connection between the buyer and the seller including a means to request connection.

7. The real estate transaction system of claim 3 further comprising a tool to get agreement between a buyer and the seller to proceed.

8. The real estate transaction system of claim 3 further comprising a verification system to crosscheck buyer and seller information and allow the parties to proceed.

9. The real estate transaction system of claim 1 further comprising a tool to facilitate a showing and further review of the real estate.

10. The real estate transaction system of claim 1 further comprising a tool to facilitate an offer for real estate and a means to allow for negotiation of an offer, a counteroffer, and an acceptance.

11. The real estate transaction system of claim 1 further comprising a tool to facilitate a formal agreement between the parties to sell and purchase real estate.

12. The real estate transaction system of claim 11 wherein the means includes a formal contract, executing the contract, satisfying necessary inspections and/or zoning or other legal requirements and closing the transaction and transferring the real estate to the buyer.

13. A real estate transaction system configured to allow one or more users to connect comprising:
a non-transitory computer-readable medium storing executable instructions;
one or more processors capable of executing the instructions;
a first user in communication with an input device;
a second user in communication with an input device;
a connection device for connecting users to the system;
a table for receiving inputs from the first user input device including desired real estate information;
a table for receiving inputs from the second user input device including real estate location, user contact, and price information;
an intent-based matching tool for connecting the first user with the second user based on the user information;
a map for displaying at least some of a user's information within a geographic location;
one or more color-coded pins;
one or more lines for visually connecting for the users the information on the map;
a tool for initially concealing a specific location associated with real estate;
a tool for later disclosing a specific location associated with the real estate;
a direct communication line that is established once the user agrees to a match;
a system for maintaining the currency of the information; and
a tool for protecting the confidentiality of the information.

14. The real estate transactions system of claim 13, further comprising an internet data exchange mapping and associated data tool.

15. The real estate transactions system of claim 13 further comprising a means to insert one or more pins to visualize interest in a desired real estate location.

16. The real estate transaction system of claim 13 further comprising a first plurality of pins having a first color and associated with real estate buyers, and a second plurality of pins having a second color and associated with real estate sellers.

17. The real estate transaction system of claim 13 further comprising a profile creation tool in communication with the table, wherein the profile creation tool includes one or more of a real estate property type, a location, and a budget.

18. The real estate transaction system of claim 13 further comprising at least one of a feedback and rating system; a price selector tool; and a negotiation assistance tool.

19. A method for facilitating real estate transactions comprising:
registering a user;
connecting a first user to a user portal;
displaying information to a first user;
registering a second user;
connecting a second user to a user portal;
displaying information to a second user;
capturing a first user's real estate needs via computer memory data tables;
capturing a second user's real estate information via computer memory data tables;
rapidly building a profile for each user;
generating a match for the users wherein matching occurs based on alignment of real estate needs and real estate information;
displaying a graphical user interface including a map having one or more pins indicating a connection between users;
pushing a match to users from which they can request to connect with one another and forming initial soft connections between users wherein confidential identifying information is hidden;
prompting users to decide whether or not to proceed beyond the soft connection whereupon the confidential information necessary to proceed is revealed;
performing external verification of user-provided information;
prompting users to proceed with the transaction or make counteroffers; and
facilitating formal closing activity upon agreement.

20. The method of claim 19, further comprising:
registering a user;
connecting a first user to a user portal;
displaying information to a first user;
registering a second user;
connecting a second user to a user portal;
displaying information to a second user;
capturing a first user's real estate needs via computer memory data tables;
capturing a second user's real estate information via computer memory data tables;
rapidly building a profile for each user;
generating a match for the users wherein matching occurs based on alignment of real estate needs and real estate information;
displaying a graphical user interface including a map having one or more pins indicating a connection between users;
pushing a match to users from which they can request to connect with one another and forming initial soft connections between users wherein confidential identifying information is hidden;
prompting users to decide whether or not to proceed beyond the soft connection whereupon the confidential information necessary to proceed is revealed;
performing external verification of user-provided information;
prompting users to proceed with the transaction or make counteroffers; and
facilitating formal closing activity upon agreement occurs a real estate transaction system configured to allow one or more users to connect comprising:
a non-transitory computer-readable medium storing executable instructions;
one or more processors capable of executing the instructions;
a first user in communication with an input device;
a second user in communication with an input device;
a connection device for connecting users to the system;
a table for receiving inputs from the first user input device including desired real estate information;
a table for receiving inputs from the second user input device including real estate location, user contact, and price information;
an intent-based matching tool for connecting the first user with the second user based on the user information;
a map for displaying at least some of a user's information within a geographic location;
one or more color-coded pins;
one or more lines for visually connecting for the users the information on the map;
a tool for initially concealing a specific location associated with real estate;
a tool for later disclosing a specific location associated with the real estate;
a direct communication line that is established once the user agrees to a match;
a system for maintaining the currency of the information; and
a tool for protecting the confidentiality of the information.
